(19) United States
(12) Patent Application Publication
(10) Pub. No.: US 2007/0222204 A1
(43) Pub. Date: Sep. 27, 2007

(54) Information tool

(75) Inventor: Raymond G. Raiskums, Etobicoke (CA)

Correspondence Address: Gowling Lafleur Henderson LLP;Suite 1600, 1 First Canadian Place, 100 King Street West, Toronto, ON, M5X 1G5, CA

(73) Assignee: PLM Group Ltd., Markham (CA)

(21) Appl. No.: 11/384,276

(22) Filed: Mar. 21, 2006

(51) Int. Cl. B42F 21/00

(52) U.S. Cl. 283/36

(57) ABSTRACT

The present invention provides a pocket sized information tool that has a flexible design and can be easily manufactured.

### FIELD OF THE INVENTION

The present invention relates to an information tool or brochure and more particularly to an information tool or brochure that is pocket or wallet sized.

### BACKGROUND OF THE INVENTION

Information brochures are frequently used to relay relevant information, for example about a place or event. Various types of brochures are known that include printed material on one or both sides of one or more pieces of paper. Such brochures may include intricate folding or may be attached to or form an envelope when used as a mailer.

Many known brochures are large in size and may not be of a size that is easy to carry or store on or by a user.

There is always a need to produce a brochure, or similar marketing tool, that includes sufficient information that needs to be relayed to a user while being compact and easily portable.

### SUMMARY OF THE INVENTION

The present invention provides a pocket sized information tool that has a flexible design.

In one embodiment the present invention provides a foldable information tool comprising first and second side edges interconnected by opposing end edges and a plurality of rows extending between the side edges defined by a plurality of first fold lines extending between the side edges and located transversely thereto; each row comprising a plurality of panels each defined by second fold lines extending between the end edges and located transversely thereto. An outer row of the plurality of rows located adjacent at least one end edge comprises at least a portion of the panel located adjacent the second side edge cut away inwardly of the second side edge and having a flap portion extending from the opposing outer panel and outwardly from the opposing first side edge.

In a further embodiment the present invention provides a foldable information tool comprising first and second side edges interconnected by opposing end edges and a plurality of rows extending between the first and second side edges and defined by a plurality of first fold lines, each row comprising at least two panels of equal size and a peripheral panel located adjacent the second side edge, the peripheral panel having a different size from the at least two panels, the panels being defined by second fold lines located transversely to the first fold lines. An outer row located adjacent at least one end edge comprising a series of panels defined by the second fold lines and having a cut away portion located adjacent the second edge and equal to the size of the peripheral panels of the other rows and having a flap portion extending from the panel adjacent the first side edge. The plurality of rows are operable to be accordion folded along first fold lines and the peripheral panels are operable to be folded inwardly onto the adjacent panels and further folded within the panels of the outer row. The flap portion is operable to be folded onto the exterior surface of the outer row and secured thereon.

The present invention also provides an information tool as described herein optionally including the feature of at least one of the fold lines or a portion thereof being perforated.

The present invention also provides an information tool as described herein optionally including a pocket located on at least one of the panels.

### BRIEF DESCRIPTION OF THE DRAWINGS

The present invention will be described in further detail below with reference to the accompanying figures in which:

FIG. 1 is an isometric view of the information tool of the present invention in its unfolded form, showing a second embodiment of the information tool in dashed outline;

FIG. 2 is an isometric view of the information tool of FIG. 1 in a partially folded form;

FIG. 3 is an isometric view of the information tool of FIG. 1 in a flattened form with its rows folded upon each other;

FIG. 4 is an isometric view of a further stage in the folding of the information tool of FIG. 1;

FIG. 5 is an isometric view of the information tool of FIG. 1 in a folded configuration with the flap portion in an open position;

FIG. 6 is an isometric view of the information tool of FIG. 5 with the flap in a closed position;

FIG. 7 is an isometric view of a semi-folded alternative embodiment of the information tool of the present invention including a pocket panel;

FIG. 8 is an isometric view of the information tool of FIG. 7 showing the pocket being formed; and

FIG. 9 is an isometric view of the semi-folded information tool of FIG. 7 with a pocket.

### DETAILED DESCRIPTION OF THE PREFERRED EMBODIMENTS

The present invention provides an information tool that is made from one single sheet that is die cut and is folded into a size that can be easily stowed in a pocket, for example a shirt pocket, or a purse, or such like. The design of the information tool allows a user to quickly access the information found on the tool and to easily fold the tool away into a pocket sized product.

The present invention provides a foldable information tool formed from a blank that is die cut that comprises a plurality of panels arranged in rows. The peripheral panel on each row being of a shorter length than the remaining panels in the row. One of the peripheral rows includes a cut away portion at its peripheral edge that is substantially equal in size to the peripheral panels on adjacent rows. Located on the opposite end of the row with the cut away portion is a flap portion that is operable to secure the information tool in a folded configuration. The rows are operable to concertina fold towards the outer row that includes the flap portion and the panels are operable to concertina fold inwardly towards the panel that is adjacent the flap portion. Once the rows and panels are folded inwardly the panels on the outer row that includes the flap portion are operable to fold over and enclose the folded panels and the flap portion can releasably secure the information tool in this folded configuration.

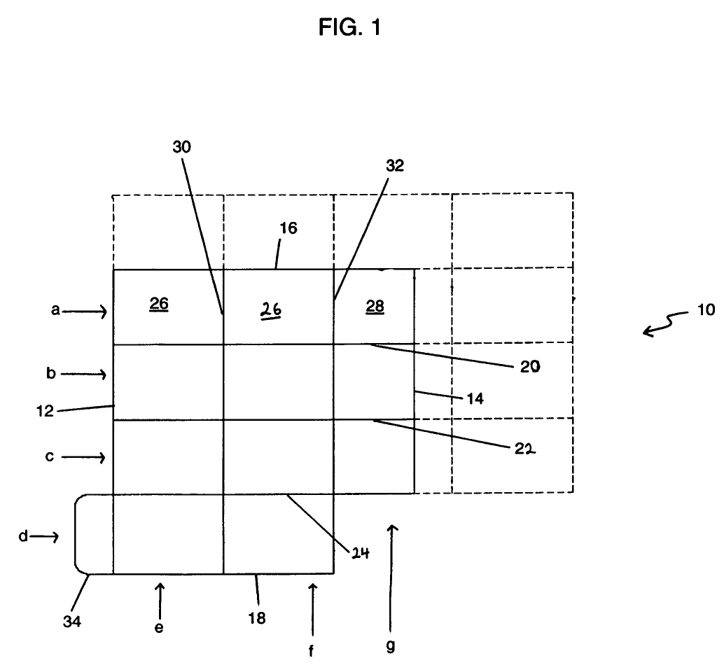

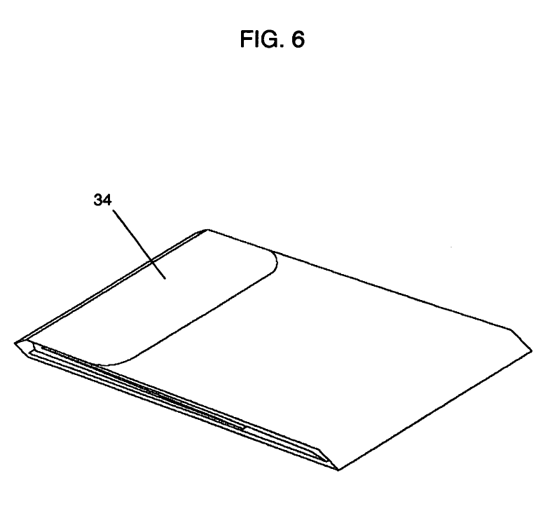

The information tool of the present invention will now be described in further detail with reference to FIG. 1, in which the information tool is indicated generally at numeral 10. FIG. 1 illustrates the unfolded configuration of the information tool 10 whereas FIG. 6 illustrates the folded configuration. The information tool may be provided in a folded or an unfolded configuration.

The dashed lines in FIG. 1 indicate an alternative embodiment for a different size of information tool, which includes additional panels. The characteristics of the information tool are the same for a larger version as that of the embodiment illustrated and discussed in detail herein. A larger information tool is made from a larger sheet and may include additional panels and rows within the sheet.

Turning to the embodiment illustrated using solid lines the information tool is a sheet 10 that has opposing first and second side edges 12, 14 interconnected by opposing end edges 16, 18. In the illustrated embodiment of FIG. 1, the sheet 10 is divided into 4 parallel rows, indicated a-d, each divided by first fold lines 20, 22 and 24, and 3 columns indicated e through g, each divided by second fold lines 30, 32.

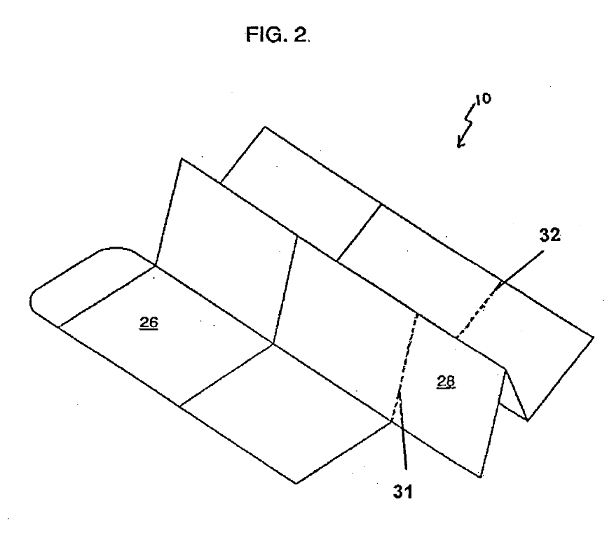

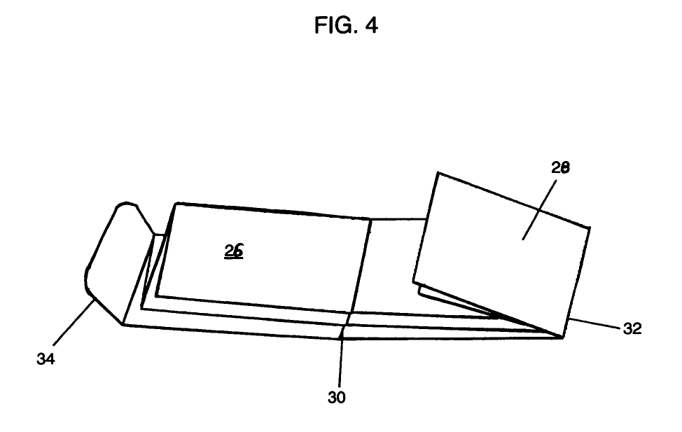

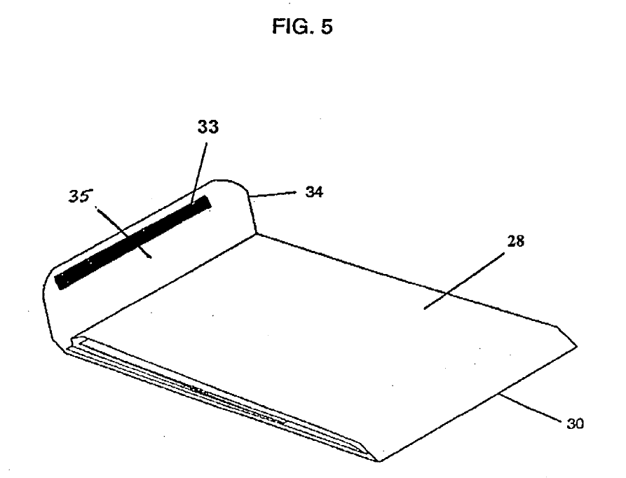

Rows a through c have the same configuration and in the illustrated embodiment of FIG. 1 each comprise two identical panels 26 located adjacent one another, one of which extends from side edge 12. Adjacent the middle panel 26, in each row a through c, is panel 28 which is smaller in size than panel 26. In particular, panel 28 has a smaller length than panel 26 but has the same height as panel 26. The panels are each defined by one or more of first fold lines 20, 22, and 24 and second fold lines 30, 32. Panel 28 has a smaller dimension to aid in the folding of the information tool 10 which will be discussed in further detail below. The first fold lines 20. 22 and 24 allow for the concertina folding of the rows, as seen in FIG. 2. The second fold lines 30, 32 allow the panels to be folded inwardly, as seen in FIGS. 4 and 5.

Row d includes two identical panels 26, also located adjacent one another and one of which extends from side edge 12. However, row d has a portion cut away from the end lying adjacent second side edge 14, and in particular in the illustrated embodiment the cut away portion is equal in size to that of panel 28, i.e. row d does not include panel 28.

Extending away from side edge 12 in row d, in the opposite direction from panel 26, is flap portion 34. Flap portion 34 may optionally include an adhesive, not illustrated, located on at least one surface that allows for the flap to be adhered to the outside surface of at least one panel when the information tool is in its folded configuration. It will be understood that the side of the panel on which the adhesive is to be placed is the side which will lie against the surface of an adjacent panel in the folded configuration, illustrated by numeral 35 in FIG. 5. The adhesive may be, for example but is not limited to, glue, however it will be understood that the adhesive could be some other form of securing means that allows the flap to be secured to at least one panel when the information tool is folded. As can be seen more clearly in FIG. 6, the adhesive attaches the flap portion 34 to the exterior surface of the panel 26 in row d that is located furthest from flap portion 34 when the sheet 10 is folded.

As stated above, panels 28 and panels 26 have equal height but differ in their length. Panel 28 has a smaller length than panel 26. Flap portion 34 has the same height as both panels 26 and 28. The length of flap portion 34 is smaller than panel 26 and preferably also smaller than panel 28. It will be understood that the length of flap portion 34 must be sufficient to be able to fold onto the exterior surface of panel 26, as described above and in further detail below, and to adhere to the exterior surface with the assistance of an adhesive.

Located on each of the panels and on both sides of the panels may be information relating to the proposed use of the information tool. For example, if the information tool is designed to be a golf course map then located on each of the panels 28, 26 may be information about each of the golf course holes, as well the general layout of the golf course and information relating to the operation of the golf course may be included. The information to be included on the information tool may be sized to fit within each individual panel of the tool and thereby require only one portion of the tool to be unfolded for viewing, or the information may be contained on the whole tool and therefore complete unfolding may be required for viewing.

The use of the information tool of the present invention will now be described in further detail with reference to FIGS. 1 through 6.

The folding and unfolding of the information tool will be described beginning with the unfolded state illustrated in FIG. 1. In the unfolded state all the rows (a through d) lie in a configuration that allows for the panels 26, 28 including the indicia thereon to be available for viewing, preferably in use this is a flat configuration. When a user wishes to fold the sheet 10, the rows a through d are operable to fold along the first fold lines 20, 22 and 24 in a concertina type fold, illustrated in FIG. 2.

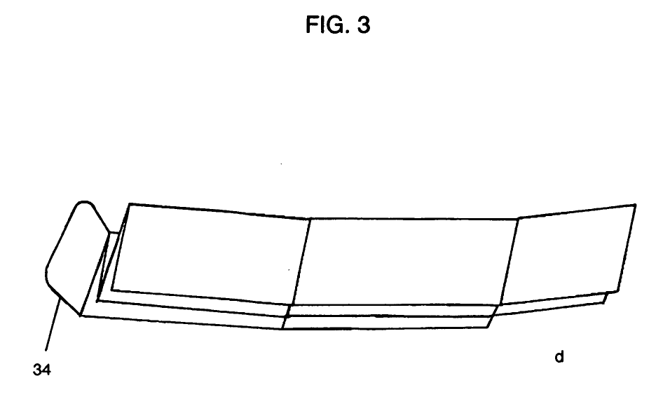

Once the rows a-d have been folded they lie flat on top of the outer row, d, as illustrated in FIG. 3. The panels 26 located on rows a through c extend outwardly from row d which does not include an outer panel 26. At this stage, the panels 26 can be folded along second fold line 32 inwardly to fold on top of panels 28, as illustrated in FIG. 4. Then the panels can be folded along second fold line 30 so that the panels are folded on top of each other, as illustrated in FIG. 5. In this configuration, only the exterior surfaces of panels 26 of row d may be seen and the remaining folded panels are located within these panels.

To secure the panels in a folded configuration, flap portion 34 is folded over the panels to lie adjacent the exterior surface of the panel 26, illustrated in FIG. 6. Flap portion 34 is secured to the exterior surface using an adhesive, as described above.

To view the information contained in the information tool 10 the user can remove flap portion 34 by peeling it away from the exterior surface of the panel 26 and open up the information tool 10 by unfolding the panels and rows as required.

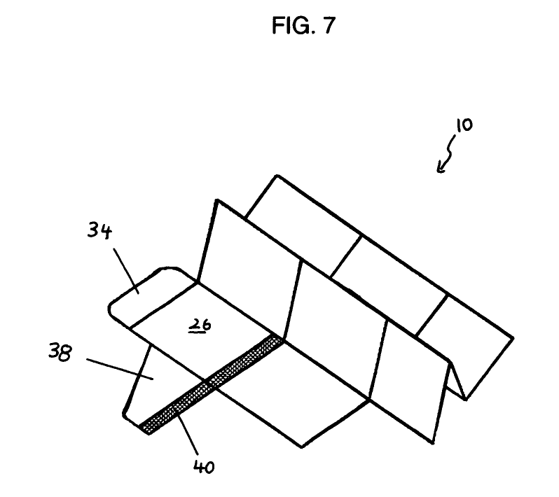

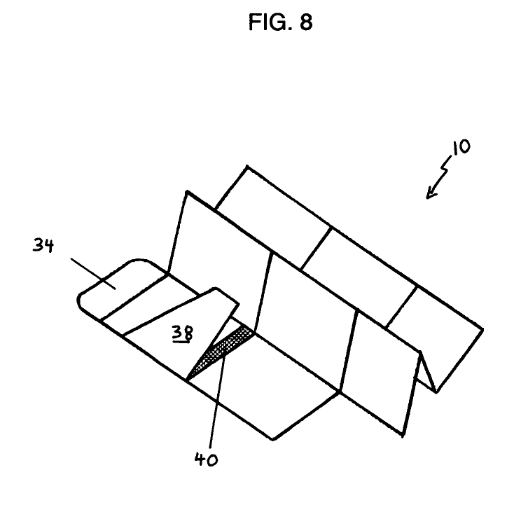

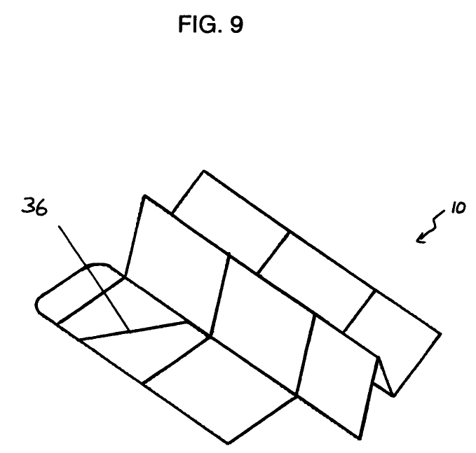

As can be seen in FIGS. 7-9, the information tool 10 may also include a pocket 36 located on the panel 26 of row d that is located adjacent the first end edge. The pocket 36 is created by folding pocket panel 38, shown in FIGS. 7 and 8, on to the panel 26 that lies adjacent the first end edge and the flap portion 34. The pocket panel 38 is created when the outline of the unfolded information tool 10 is first cut, as discussed below. It will be understood that if a pocket is not required on the final product then the pocket panel 38 does not need to be included in the blank or unfolded cut information tool 10.

The pocket panel 38 is attached to the panel 26 to form pocket 36 using suitable adhesive. The adhesive is placed along the adhesive strip 40. The adhesive strip 40 may extend along a portion of both the pocket panel 38 and panel 26, as illustrated in FIGS. 7 and 8, or along a portion of one of the pocket panel 38 and panel 26. The amount and placement of the adhesive should be sufficient to adhere the pocket panel 38 to the panel 26 while creating a sufficient pocket size for the end use. An example of one end use may be to hold a hotel room key.

The illustrated embodiment shows the pocket being formed on the inside face of the panel 26 adjacent the flap portion 34 so that the pocket is held within the folded information tool 10. However, it will be understood that the pocket may also be created on the outside surface of the panel 26 so that the pocket is located on the outside of the folded information tool 10. In order to create the pocket on the outside of the information tool 10 the pocket panel 38 is folded in the opposite direction on to the surface of the panel 26 that forms the external face of the folded information tool 10.

In a further embodiment, the information tool may include perforated lines along any one of the first and second fold lines to allow a user to remove part of the information tool if so required. For example, the information tool 10 may include a perforated line along the second fold line 32 that defines the outer most panels, i.e. the second fold line that lies adjacent the second side edge 14. The inclusion of perforations along second fold line 32 allows a user to remove the outer panels defined by second side edge 14 and second fold line 32 if so desired. An example of an information tool that may include a perforated section is one that includes a form for completion by a user but where the remaining information is to be kept by the user. The perforation therefore allows a user to return part of the information tool while keeping the remaining information in a foldable configuration.

It will be understood by a person skilled in the art that the dimensions of the panels 26, 28 in the information tool may vary and are not limited to the examples provided herein. As can be seen in FIG. 1, a second embodiment of the information tool 10 is shown in dashed lines. This embodiment illustrates an optional different size for the information tool. As stated herein, the information tool is not limited to a particular size. The size of the information tool is governed by the desired end use.

The manufacturing steps for the information tool 10 will now be briefly discussed. Initially the colour images may be printed on the paper stock using an offset or digital printing press. Such machines are well known in the art. It will be understood that the size of the paper stock to be used will be chosen based on the size of the final product.

The pre-printed sheets may then be passed through a die-cutting machine, or press, to cut the outline of the information tool 10 to the correct size and format, i.e. including a pocket if the end product is so designed. At this stage the fold lines are scored into the paper stock and the perforations, if required, are included. Once the paper stock has been printed and die cut the sheets are then folded and glued on a finishing production machine that is configured for the particular folding requirements of the information tool 10 described herein. Such machines described herein are known and used in the art.

The information tool of the present invention may be tailored to suit a wide variety of applications and can be easily stowed in a shirt pocket or purse. The folding pattern of the information tool allows for easy access to helpful information such as, but not limited to, street maps, hotel layouts, golf courses, trail maps, city tourism guides, trade show guides, public transit map, campground map, gift card holder and coupon package etc. After viewing the information a user can quickly refold the information tool to its original size and store away until the next use.

As discussed above, the information tool has a flexible design that allows for various sizes and panels and optionally a glued pouch. The pouch may be used in as application such as hotel maps with a pouch for a room key. In addition, the information tool may be made in a standard size of 4″×3″ which can be used as a direct mail vehicle.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

1. A foldable information tool comprising:
first and second side edges interconnected by opposing end edges;
a plurality of rows extending between the side edges defined by a plurality of first fold lines located transversely to the side edges; each row comprising a plurality of panels each defined by a plurality of second fold lines located transversely to the end edges, including a peripheral panel adjacent to the second side edge, the peripheral panels in each row having a decreased length relative to the adjacent panels;
a flap portion extending from the first side edge of a row in a direction opposite to the second side edge, wherein the rows are operable to be folded along the first fold lines onto the row from which the flap portion extends and then folded inwardly along second fold lines from the peripheral panels to the flap portion to form a folded panel configuration, and wherein the flap portion is operable to fold onto the folded panels.

2. The foldable information tool according to claim 1, wherein one of the rows located adjacent at least one end edge comprises at least a portion of the panel located adjacent the second side edge cut away inwardly of the second side edge.

3. The foldable information tool according to claim 1, wherein the flap portion extends from the first side edge of a row located adjacent an end edge.

4. The foldable information tool according to claim 2, wherein the cut away portion is sized to correspond to the peripheral panel located adjacent thereto.

5. The foldable information tool according to claim 3, wherein the flap portion comprises attachment means for securing the flap portion to an external surface of the sheet when folded.

6. The foldable information tool according to claim 1, wherein the sheet is pocket sized when folded.

7. (canceled)

8. The foldable information tool according to claim 1, wherein at least a portion of one of the fold lines is perforated.

9. The foldable information tool according to claim 1, wherein the panel adjacent the flap portion further comprises a pocket panel extending outwardly from the end edge, the pocket panel operable to fold towards the panel adjacent the flap portion to define a pocket therewith.

10. A foldable information tool comprising:
first and second side edges interconnected by opposing end edges;
a plurality of rows extending between the first and second side edges and defined by a plurality of first fold lines, each row comprising at least two panels of equal size and a peripheral panel located adjacent the second side edge, the peripheral panel having a different size from the at least two panels, the panels being defined by second fold lines located transversely to the first fold lines;
an outer row located adjacent at least one end edge comprising a cut away portion located adjacent the second side edge substantially equal to the size of the peripheral panels of the other rows and further comprising a flap portion extending outwardly from the first side edge in a direction opposite to the second side edge;
the plurality of rows operable to be accordion folded along first fold lines and the peripheral panels operable to be folded inwardly onto the adjacent panels and further folded within the panels of the outer row, the flap portion operable to be folded and releaseably secured onto the exterior surface of the outer row to secure the information tool in a folded configuration.

11. The foldable information tool according to claim 10, wherein the flap portion comprises adhesive for releaseably securing the flap portion to the exterior surface of the outer panel when the information tool is folded.

12. The foldable information tool according to claim 10, wherein at least one of the panels include indicia thereon.

13. The foldable information tool according to claim 10, wherein at least a portion of one of the fold lines is perforated.

14. The foldable information tool according to claim 1, wherein the panel adjacent the flap portion comprises a pocket.
